(19) United States
(12) Patent Application Publication
(10) Pub. No.: US 2004/0106342 A1
(43) Pub. Date: Jun. 3, 2004

(54) Nonwoven roll towels having antimicrobial characteristics

(76) Inventors: Raymond C. Sturm, Spartanburg, SC (US); Jason L. Kreider, Boiling Springs, SC (US)

Correspondence Address: Charlotte C. Wilson, Legal Department, M-495, PO Box 1926, Spartanburg, SC, 29304, US

(21) Appl. No.: 10/418,019

(22) Filed: Apr. 17, 2003

Related U.S. Application Data
(63) Continuation-in-part of application No. 10/306,968, filed on Nov. 29, 2002.
(63) Continuation-in-part of application No. 10/307,027, filed on Nov. 29, 2002.

(51) Int. Cl. B32B 27/04; B32B 27/12

(52) U.S. Cl. 442/117; 442/110; 442/408; 442/394

(57) ABSTRACT

The present disclosure relates to roll towels made from a nonwoven fabric and treated with a silver-ion containing compound to impart antimicrobial characteristics to the fabric. Specifically, the nonwoven fabric of one preferred embodiment is comprised of composite fibers that are at least partially split into their microdenier elementary components. Such structure provides a greater surface area onto which the silver ions may adhere, thus increasing the amount of surface-available silver. This structure further causes the fabric to be highly absorbent, despite being made of synthetic materials.

### CROSS-REFERENCE TO RELATED APPLICATIONS

This application of a Continuation-in-Part of U.S. patent application Ser. No. 10/306,968 and U.S. patent application Ser. No. 10/307,027, both filed Nov. 29, 2002, entitled “Fabrics Having a Topically Applied Silver-Based Finish Exhibiting Improved Wash Durability” and “Fabrics Having a Topically Applied Silver-Based Finish Exhibiting a Reduced Propensity for Discoloration” respectively, each of which is incorporated by reference herein.

### TECHNICAL FIELD

The present disclosure relates to the field of cabinet roll towels and other absorbent materials. More specifically, it relates to roll towels made from a nonwoven fabric and treated with chemicals to impart antimicrobial characteristics to the fabric. Specifically, the nonwoven fabric of one preferred embodiment is comprised of composite fibers that are at least partially split into their microdenier components. Such structure provides a greater surface area onto which the silver ions may adhere, thus increasing the amount of surface-available silver. The structure further causes the fabric to be highly absorbent, despite being made of synthetic materials.

### BACKGROUND

Cabinet roll towels (CRTs) have long been used in public restroom facilities as an alternative to hot air dryers or paper towels. These roll towels typically are mounted in a wall hanging cabinet having supply and take-up rolls such that the user can pull down a clean, unused segment of the towel from the supply roll with the previously used segment of the towel being conveyed back to the take-up roll. When the length of toweling has been exhausted, or on some prescribed frequency, a laundry service removes the cabinet roll towel for cleaning and replaces it with a fresh CRT.

Historically, CRTs have been made of cotton, because of its high absorbency and soft feel. Unfortunately, cotton has a limited durability as compared with synthetic fibers that tend to better withstand industrial laundry conditions.

Most roll towels, whether cotton or synthetic, are formed from woven fabric structures as are well known to those of skill in the art. Generally, seaming along the edges is required to prevent the towel from unraveling during use. The seams, however, tend to cause the roll towel to have a thicker diameter at the edges than in the middle of the roll. Accordingly, the seam thickness, when accumulated as the towel is wound onto a supply roll, can reduce the length of toweling that can be positioned on a roll. This problem is successfully addressed in U.S. Pat. No. 6,001,442 to Rockwell, Jr., which discloses the use of ultrasonic seaming to seal the edges of, or splice segmented portions of, a polyester roll towel.

U.S. Pat. No. 3,776,797 to Thomas et al. describes a nonwoven roll towel made of a central layer of open mesh to which multi-ply layers of cellulosic tissue are adhesively bonded. The open mesh is comprised of resilient warp threads and stretchable non-resilient fill threads. The composite, after being embossed, is perforated into individual towels by knives that cut substantially all the warp threads. Such a product is different from the continuous roll toweling disclosed herein. Further, the '797 patent does not disclose the use of a hydroentangled nonwoven web, nor the application of antimicrobial chemistry to a microdenier nonwoven web.

Recent discussions in the media have intensified consumer concern over the spread of germs in public facilities, such as restrooms. The manufacturers of roll towels have made little progress in dispelling those concerns, either by suggesting more frequent laundering of the towels or by treating the roll towels with antimicrobial chemical compounds. One such attempt is described in Japanese Patent Application No. 7178998 to Nishio Ryoichi, in which a woven polyester/cotton roll towel has been treated with zeolite carrying silver ions. This roll towel fails to overcome the problems of towel durability and seaming. Because the fabric is woven, there will likely be a tendency for the edges to unravel. The present disclosure, in which a nonwoven roll towel is treated with a silver-ion containing antimicrobial compound, represents an advancement over the Ryoichi roll towel.

The subject of the present disclosure addresses and overcomes the problems described above. A synthetic nonwoven fabric is used in place of the woven cotton used historically. The present fabric is treated with a silver-based antimicrobial agent. The resultant roll towel is durable and does not require seaming. For these reasons and others that will be described herein, the present roll towel represents a useful advance over the prior art.

### SUMMARY OF THE INVENTION

The present roll towel is comprised of a nonwoven fabric that has been treated with a silver-based antimicrobial agent. In one embodiment, the present towel resists the build-up of odor-causing bacteria. The nonwoven fabric may be comprised of continuous microdenier filaments that enhance the fabric's absorbency and that are believed to provide greater surface area onto which the silver ions may be applied.

### DETAILED DESCRIPTION

Textile Substrate

Nonwovens are known in the textile industry as an alternative to traditional woven or knit fabrics. To create a nonwoven fabric, a filament web must be created and then consolidated. In one method, staple fibers are formed into a web through the carding process, which can occur in either wet or dry conditions. Alternatively, continuous filaments, which are formed by extrusion, may be used in the formation of the web. The web is then consolidated, and/or bonded, by means of needle-punching, thermal bonding, chemical bonding, or hydroentangling. A second consolidation method may also be employed.

One preferred substrate for use in the roll towel of the present disclosure is a nonwoven fabric formed of continuous splittable filaments that are extruded as a web and then consolidated. Preferably, the nonwoven web is consolidated through hydroentanglement, and, more preferably, through hydroentanglement followed by thermal bonding. The continuous composite filaments are obtained by means of a controlled spinning process, and the hydroentanglement process mechanically splits the composite filaments into their elementary components.

The continuous filaments have the following characteristics: (1) the continuous filaments are comprised of at least two elementary filaments and at least two different fiber types; (2) the continuous filaments are splittable along at least a plane of separation between elementary filaments of different fiber types; (3) the continuous filaments have a filament number (that is, titer or yarn count) of between 0.3 dTex and 10 dTex; and (4) the elementary filaments of the continuous filament have a filament number between 0.005 dTex and 2 dTex. Simply put, the nonwoven fabric can be described as a nonwoven fabric of continuous microfilaments. Such a fabric is described in U.S. Pat. Nos. 5,899,785 and 5,970,583, both to Groten et al., each of which is incorporated herein by reference.

A wide range of synthetic materials may be utilized to create the elementary filaments of the continuous composite filaments. As such, the group of polymer materials forming the elementary filaments may be selected from among the following groups: polyester and polyamide; polyolefin and polyamide; polyester and polyolefin; polyurethane and polyamide; polyester, polyolefin, and polyamide; aliphatic polyester and aromatic polyester; acrylic polymers and polyamides; and other combinations thereof.

The term “polyamide” is intended to describe any long-chain polymer having recurring amide groups (—NH—CO—) as an integral part of the polymer chain. Examples of polyamides include nylon 6; nylon 66; nylon 11; and nylon 610. The term “polyester” is intended to describe any long-chain polymer having recurring ester groups (—C(O)—O—). Examples of polyesters include aromatic polyesters, such as polyethylene terephthalate (PET), polybutylene terephthalate (PBT), and polytrimethylene terephthalate (PTT), and aliphatic polyesters, such as polylactic acid (PLA).

The composite filaments can have a variety of configurations. The core portions of the composite filaments can be of one fiber type. Alternatively, fibers having no core portion (that is, hollow core composite filaments) and fibers without a recognizable “core” are suitable for use in the present invention as well. The composite filaments typically have a symmetrical cross-section having a central median axis. However, the composite filament can be unsymmetrical, having elementary filaments with non-uniform cross-sections. The cross-section of the composite filaments can be substantially circular in shape or can be comprised of multiple lobes that are joined at a central region. Another variation of the construction of splittable composite filaments is one having a cross-section in which ribbons, or fingers, or one component are positioned between ribbons, or fingers, of a second different component. Yet another variation includes either one or a plurality of elementary filaments of one material that are integrated in a surrounding matrix of a second different material.

While a potentially preferred nonwoven fabric has been described, it is believed that any microdenier nonwoven fabric that has been treated with the silver-based antimicrobial chemistry described herein would fall within the scope of the present disclosure.

Furthermore, the substrate may be dyed or colored with any type of colorant, such as, for example, pigments, dyes, tints, and the like. Other additives may be present on and/or within the target fabric or yarn, including antistatic agents, brightening compounds, nucleating agents, antioxidants, UV stabilizers, fillers, permanent press finishes, softeners, lubricants, curing accelerators, and the like. The present fabric may also be coated, printed, colored, dyed, and the like.

The particular microdenier nonwoven fabric described above provides many advantages over materials previously used to create roll towels. First, the fabric is surprisingly absorbent, despite its synthetic content, having an absorbency that is equal to that of cotton towels. Second, because the fabric is synthetic, the roll towel is very durable and dries quickly, representing a material and energy savings for the industrial laundry. Third, the fabric is quite thin and lightweight, as compared with traditional woven cotton fabrics. The thinness of the present fabric allows a longer length of towel to be rolled onto a supply roll for insertion into the towel cabinet, thus representing an advantage for the end user and the industrial laundry (that is, less frequent launderings). In addition, the fabric's nonwoven construction does not unravel when cut, thereby eliminating the need for seaming along the perimeter of the roll towel. Finally, the microdenier structure of the present fabric provides a greater surface area onto which the antimicrobial agent may be applied, thus effectively increasing the amount of surface-available silver. These advantages represent a useful advancement over the prior art.

Antimicrobial Agents

There has been a great deal of attention in recent years given to the hazards of bacterial contamination from potential everyday exposure. Noteworthy examples of such concern include the fatal consequences of food poisoning due to certain strains of Eschericia coli (E. coli) being found within undercooked beef in fast food restaurants; Salmonella contamination causing sicknesses from undercooked and unwashed poultry food products; and illnesses and skin infections attributed to Staphylococcus aureus, Klebsiella pneumoniae, yeast, and other unicellular organisms.

With such an increased consumer interest in this area, manufacturers have begun introducing antimicrobial agents within various household products and articles. For instance, certain brands of polypropylene cutting boards, liquid soaps, detergents, and the like all contain antimicrobial compounds. The most popular antimicrobial agent for such articles is triclosan.

Although the incorporation of such a compound within liquid or polymeric media has been relatively simple, other substrates, including the surfaces of textiles and fibers, have proven less accessible. There is a long-felt need to provide effective, durable, and long-lasting antimicrobial characteristics for textile surfaces. Such proposed applications have been extremely difficult to accomplish with triclosan, particularly when wash durability is a necessity, because of the ease with which triclosan washes off any such surfaces.

Moreover, although triclosan has proven effective as an antimicrobial compound, the presence of chlorines and chlorides within such a compound causes skin irritation, making triclosan unsuitable for use in fibers, films, and textile fabrics. One alternative to applying the triclosan compound to the fibers or textile is to co-extrude the compound into the fibers, as has been achieved by Celanese and Acordis with acrylic and/or acetate fibers into which triclosan has been extruded. This extrusion process, however, is expensive and is not compatible for use with and within polyester, polyamide, cotton, spandex, and the like.

Silver-containing inorganic microbiocides have recently been developed and utilized as antimicrobial agents on and within a plethora of different substrates and surfaces. In particular, such microbiocides have been adapted for incorporation within melt-spun synthetic fibers, as taught within unexamined Japanese Patent Application No. H11-124729, in order to provide certain fabrics that selectively and inherently exhibit antimicrobial characteristics.

In addition, attempts have been made to apply such specific microbiocides on the surfaces of fabrics and yarns with little success in terms of durability. A topical treatment with such compounds has not been successfully applied as a durable finish or coating on a fabric or yarn substrate. Although such silver-based agents provide excellent, durable, antimicrobial properties, incorporation within melt-spun fibers is the only manner available within the prior art of providing a long-lasting, wash-resistant, silver-based antimicrobial textile. However, such melt-spun fibers are expensive to produce due to the large amount of silver-based compound required to provide sufficient antimicrobial activity, especially in light of the migratory characteristics of the compound from within the fiber itself to its surface.

A topical coating is also desirable for textile and film applications, particularly after finishing of the target fabric or film. A topical procedure permits treatment of a fabric's individual fibers before or after weaving, knitting, and the like, in order to provide greater versatility to the target yarn without altering its physical characteristics. Such a coating, however, must prove to be wash durable to be considered functionally acceptable. Furthermore, it is highly desirable for such a metallized treatment to be electrically non-conductive on the target fabric, yarns, and/or film surface. With the presence of metals and metal ions, it has been difficult in the past to obtain a wash-durable, electrically non-conductive coating.

The particular treatment used herein comprises at least one type of silver-ion containing compounds, or mixtures thereof of different types. The term “silver-ion containing compounds” encompasses compounds that are either ion-exchange resins, zeolites, or, possibly, substituted glass compounds that release the particular metal ion bonded thereto upon the presence of other anionic species. The preferred silver-ion containing compound for this invention is an antimicrobial silver zirconium phosphate available from Milliken & Company, under the tradename ALPHASAN®. Other potentially preferred silver-containing antimicrobials in this invention, including silver zeolites, such as those available from Sinanen under the tradename ZEOMIC® AJ, and silver glass, such as those available from Ishizuka Glass under the tradename IONPURE®), may be utilized either in addition to, or as a substitute for, the preferred species.

Generally, such a metal compound is added in an amount from about 0.01% to about 40% by total weight of the particular treatment composition; more preferably, from about 0.05% to about 30%; and most preferably, from about 0.1% to about 30%. Preferably, this metal compound is present in an amount from about 0.01% to about 10% of the weight of the fabric (owf), preferably from about 0.05% to about 5% owf, more preferably from about 0.1% to about 3% owf, and most preferably about 2.5% owf. The treatment itself, including any necessary binders, leveling agents, adherents, thickeners, and the like, is added to the substrate in an amount of about 0.01% to about 10% owf.

The binder material provides highly beneficial durability of the antimicrobial compound for the microdenier yarns of the nonwoven substrate. Preferably, this component is a polyurethane-based binding agent, although other binders, such as a permanent press type resin or an acrylic type resin, may also be used in combination, particularly with the halide ion additive for discoloration reduction. In essence, such resins provide washfastness by adhering silver to the target fabric surface and/or yarns, with the polyurethane exhibiting the best overall performance for wash durability results.

Application Method

The preferred procedure utilizes silver-ion containing compounds, such as either ALPHASAN®, ZEOMIC®, or IONPURE® as preferred compounds (although any similar types of compounds that provide silver ions may also be utilized), which are admixed with a binder with a bath, into which the target fabric is then immersed.

In terms of wash durability of the antimicrobial article, initial attempts to understand the ability of such metal-ion containing compounds to attach to a fabric surface yielded a procedure in which a sample of ALPHASAN® antimicrobial chemical was first exhausted from a dye bath onto a target polyester fabric surface. The treated fabric exhibited excellent log kill rate characteristics; however, upon washing in a standard laundry method (AATCC Test Method 103-1981, for instance), the antimicrobial activity was drastically reduced. These promising initial results led to the inventive wash-durable antimicrobial treatment wherein the desired metal-ion containing compound would be admixed with a binder resin for application on the target fabric surface.

It was initially determined that proper binder resins could be selected from the group consisting of nonionic permanent press binders (i.e., cross-linked adhesion promotion compounds, including, without limitation, cross-linked imidazolidinones available from Sequa under the tradename Permafresh®) or slightly anionic binders (including, without limitation, acrylics such as Rhoplex® TR3082 from Rohm & Haas). Other nonionics and slightly anionics were also suitable, including melamine formaldehyde, melamine urea, ethoxylated polyesters (such as Lubril QCX™, available from Rhodia), and the like. However, it was found that the wash durability of such treated fabrics, in terms of silver ion retention at least, was limited.

It was determined that greater durability was required for this type of application. Thus, these prior comparative treatments were measured against various other types. Finally, it was discovered that certain polyurethane binders (such as Witcobond® from Crompton Corporation) and acrylic binders (such as Hystretch® from BF Goodrich) permitted the best overall wash durability to the solid silver-ion compound adhesion to the target fabric surfaces, as discussed below.

With such specific polyurethane-based binder materials utilized, the antimicrobial characteristics of the treated fabric remained very effective after as many as ten industrial laundering procedures and somewhat effective after as many as thirty industrial laundering procedures as shown in TABLES 1A and 1B below.

An acceptable method of providing a wash-durable antimicrobial metal-treated fabric surface, is the application of a silver-ion containing compound and polyurethane-based binder resin from a bath mixture. In practice, this mixture of compound and resin may be applied through spraying, dipping, padding, foaming, and the like.

It has been noticed that silver-ion topical treatments are susceptible to yellowing, browning, graying, and, possibly, blacking after exposure to atmospheric conditions. As silver ions are generally highly reactive with free anions, and most anions that react with silver ions produce color, a manner of curtailing, if not outright preventing, problematic color generation upon silver ion interactions with free anionic species, particularly within dye bath liquids, was required. Thus, it was theorized that inclusion of an additive that was non-discoloring itself, would not react deleteriously with the binder and/or silver-ion compound, and would apparently, and without being bound to any specific scientific theory, react in such a manner as to provide a colorless salt with silver ions, was highly desired.

Halide ions, such as from metal halides (for example, magnesium chloride) or hydrohalic acids (for example, hydrogen chloride) provide such results, apparently, with the exception that the presence of sodium ions (which are of the same valence as silver ions, and compete with silver ions for reaction with halide ions) should be avoided, since such components prevent the production of colorless silver halides, leaving the free silver ions the ability to react thereafter with undesirable anions. Thus, the presence of monovalent sodium ions (as well as other monovalent alkali metal ions, such as potassium, cesium, and lithium, at times) does not provide the requisite level of discoloration reduction. In general, amounts of 20 ppm or greater of sodium ions within the finish composition, particularly within the solvent (water, for example) are deleterious to the discoloration prevention of the topically applied antimicrobial treatments.

Thus the term “substantially free from sodium ions” is used to indicate a presence of no more than this threshold amount of 20 ppm, and, more preferably, no more than 5 ppm.

Furthermore, the bivalent or trivalent (and some monovalent) metal halide counteracts some effects of sodium ion exposure if present in a sufficient amount within the finish composition. Thus, higher amounts of sodium or like alkali metal ions are present within the finish composition; higher amounts of metal halide, such as magnesium chloride, for example, can counterbalance the composition to the extent that discoloration can be properly prevented. Additionally, all other metal ions—whether bivalents, trivalents, and the like, with bivalents, such as magnesium, being most preferred—combined with halide anions (such as chlorides, bromides, iodides, as examples, with chloride most preferred), as well as acids (such as HCl, HBr, and the like), are potential additives for discoloration prevention.

The concentrations of chloride ion should be measured in terms of molar ratios with the free silver ions available within the silver-ion containing compound. A range of ratios of chloride to silver ions should be from 1:10 to 5:1 for proper activity; preferably, the range is from 1:2 to about 2.5:1. Again, higher amounts of metal halide in molar ratio to the silver ions may be added to counteract any excess alkali metal ion amounts within the finish composition itself.

The following examples further illustrate the present antimicrobial article but are not to be construed as limiting the invention as defined in the claims appended hereto. All parts and percents given in these examples are by weight unless otherwise indicated.

Initially, a solution of ALPHASAN® silver-based ion exchange compound (available from Milliken & Company) was produced for topical application via bath to the target fabric. This solution was as follows:

### EXAMPLE 1

| | Amount |
|---|---|
| Component | (by weight) |
| Low sodium water | 90.86% |
| Witcobond (polyurethane binder) | 5.39% |
| Milease TS (anti-soil redeposition polymer) | 2.82% |
| ALPHASAN ® antimicrobial agent | 0.90% |
| Freecat MX (Magnesium chloride) | 0.02% |

This solution was then applied to the sample fabric (colored “true” white) via pad and nip rolls to give a wet pick-up of about 85-90% owf. The level of the active ALPHASAN® compounds on the target fabric was about 0.5-1.0% owf.

In terms of wash durability of the antimicrobial fabric, Example 1 was tested for silver content after various numbers of washes.

“Industrial Wash Procedure”

The fabric of Example 1 was tested as described below. The sample fabric was laundered in an industrial (Milnor type) washing machine equipped with a temperature controller set to wash at 160°F.+/−5° F. The rinse temperature was set to 150° F.+/−5° F. Total fabric load was set at 23 pounds. Six ounces of a solvenated surfactant (120° F. cloudpoint) and three ounces of alkali (having pH 11-11.5) were added during an 18-minute wash cycle. Six ounces of bleach were added in the washes indicated below, during an eight-minute bleach cycle. The fabric was then rinsed for two minutes followed by the introduction of one ounce of sodium bisulfite (“Antichlor”) and followed by an additional two-minute rinse at 125° F.+/−5° F. In the trials conducted without bleach, the wash procedure moved from the 18-minute wash cycle to the rinse steps. Fabrics were then extracted for five minutes at low speed, after which they were removed and dried in a conventional dryer.

Total ALPHASAN® Content Test

The amount of active ALPHASAN® compound transferred to the fabric of Example 1 in the application process, as well as the amount of ALPHASAN® compound remaining after various numbers of washes, was determined using the following Ash Procedure and Ash Digestion techniques.

In the Ash Procedure technique, a sample of fabric (weighing approximately 10 grams and measured to four significant digits) was placed in a clean, dry crucible. The crucible containing the fabric sample was placed in a muffle furnace whose temperature ramped up at 3° C./minute to 750° C. The temperature was then held at 750° C. for one hour. The system was then cooled and the crucible transferred to a desiccator in which it was allowed to reach an equilibrium temperature. The crucible was then weighed.

In the Ash Digestion technique, the fabric sample was then ground in the crucible to obtain a uniform sample of approximately 0.1 g weight (again measured to four significant digits). Four milliliters of 50% HNO₃, followed by 10 drops of 48% HF, were added to the sample. The sample was heated over a hot plate until it completely dissolved. The sample solution was then transferred to a 100 mL volumetric flask.

The crucible was then rinsed with 5% HNO₃, with the rinse solution being added to the flask. The solution was diluted to the 100 mL mark with 5% HNO₃. The dilute solution was transferred to a polyethylene storage container. Analysis for the desired active ingredient (in this case, silver) was performed using an Inductively Coupled Plasma device (e.g., a Perkin Elmer Optima 4300DV). Calculations are apparent to one skilled in the art. Numbers are reported as percent of ALPHASAN® on the fabric. In this embodiment, ALPHASAN® comprises 3.8% silver ion.

TABLES 1A and 1B show that 13% of the ALPHASAN® compound remains on the fabric after 10 washes with bleach, while 5.6% of the ALPHASAN® remains on the fabric after 30 washes with bleach. After 10 washes without bleach, 9.8% of the ALPHASAN® compound remains on the treated fabric. The durability of the ALPHASAN® compound, when applied as described herein, is further supported by the results of the Biological Solution Test (see TABLES 2A and 2B).

TABLE 1A
Industrial Wash Procedure
Fabric of Example 1, Washed with Bleach

| Number | % Alphasan ® on Fabric as | % Alphasan ® Retained |
|---|---|---|
| of Washes | Detected by Ag Content | after Washing |
| 0 | 0.54% | — |
| 10 | 0.07% | 13% |
| 30 | 0.03% | 5.6% |

TABLE 1B
Industrial Wash Procedure
Fabric of Example 1, Washed without Bleach

| Number | % Alphasan ® on Fabric as | % Alphasan ® Retained |
|---|---|---|
| of Washes | Detected by Ag Content | after Washing |
| 0 | 0.61% | — |
| 10 | 0.06% | 9.8% |

Example 1 was tested for silver ion release after various numbers of washes under a Biological Solution (Artificial Sweat) Test that is described below.

Biological Solution (Artificial Sweat) Test

This test measures the amount of active metal ion that freely dissociates from the substrate to perform a desired function (such as antimicrobial activity for odor control or reduction) and can be performed on washed or unwashed samples to monitor durability of the releasable active ingredient, in this case, silver ions. The test itself involves subjecting the sample (a swatch of fabric having 4 inch by 4 inch dimensions in this instance and weighing about 10 grams) to a solution that is representative of the solution to which a sample would be exposed to perform its desired function. Thus, for this test, the sample fabrics were first weighed to four significant digits and were then exposed to a human body odor control standard in accordance with the solution of AATCC Test Method 15-1994.

The exposure consisted of immersion in a tenfold dilution of the artificial standard solution for 8 hours. When the exposure time concluded, the sample was then dried and weighed again. Any loss in weight was then representative of the release of silver ion active ingredients to combat the odor-producing microbes within the standard solution. The calculations are reported as ppb active ingredient on the weight of the sample fabric. The results were as follows for Example 1, with washing having been conducted according to the Industrial Wash Procedure either in the presence or absence of bleach:

TABLE 2A
Silver Ion Release Measurements via Artificial Sweat Test
Fabric of Example 1, Washed with Bleach

| Number | ALPHASAN ® | % ALPHASAN ® |
|---|---|---|
| of Washes | on Fabric (ppb) | Retained |
| 0 | 1747 | — |
| 5 | 145 | 8.41% |
| 10 | 80 | 4.58% |
| 20 | 34 | 1.95% |
| 30 | 30 | 1.72% |

TABLE 2A
Silver Ion Release Measurements via Artificial Sweat Test
Fabric of Example 1, Washed without Bleach

| Number | ALPHASAN ® | % ALPHASAN ® |
|---|---|---|
| of Washes | on Fabric (ppb) | Retained |
| 0 | 1950 | — |
| 5 | 179 | 9.18% |
| 10 | 201 | 10.3% |

Thus, the inventive Example, through ten washes, maintained a level of silver ion release that is capable of controlling bacteria. The treated fabric, through ten washes, retains between 8 and 9% of the original silver ion release (that is, the silver ion release before washing) and continues to release silver ions through 30 industrial washes with bleach.

Acceptable performance was obtained although the fabric was exposed to laundering with bleach, a condition normally experienced by roll towels in industrial laundries, but not normally associated with the laundering of silver-containing antimicrobial articles. This represents the first reported durability of a silver-containing antimicrobial article when subjected to industrial laundry conditions including bleach.

Biological Testing

The fabric of Example 1, which had been washed with bleach according to the Industrial Wash Procedure, was tested for biological performance. Efficacy against bacteria was assessed using the “Vial Drop Method” (Modified AATCC Method 100). Portions (approximately 0.5 g) of each fabric or fiber sample were placed in glass vials, steam autoclaved, and then dried before testing. In some cases, samples were compressed by placing a glass rod on top of the portion of fabric in the vials during autoclaving and drying.

Samples were exposed to bacteria (0.5 mL of 10 E5 cells/mL) suspended in 100 mM Na/K phosphate buffer for 18-22 hours at 37° C. After incubation, the samples were washed to remove attached cells. The number of viable cells in the wash solution was quantified using a microtiter plate-based “Most Probable Number” assay. In the tables below, “Viability” refers to the number of bacteria added to the sample. The “Internal Control” is a piece of untreated polyester fabric against which all samples are measured. The “Sample Control” is a piece of untreated nonwoven fabric. The “Maximum Value” is based on the logarithm of the number of bacteria on the internal control after the exposure time minus the logarithm of the minimum number of bacteria that can be counted in the test.

Single samples were tested against Klebsiella pneumoniae ATCC #4352 and Staphylococcus aureus ATCC #6538 in two separate experiments, the average of the logarithms from the two trials being recorded in TABLES 3A and 3B below.

TABLE 3A
Klebsiella pneumoniae

| Sample Description | Average Log Kill Rate | Std. Deviation |
|---|---|---|
| Viability | 3.12E+05 | 1.03E+05 |
| Internal Control | −0.89 | 0.58 |
| Sample Control | 0.01 | 0.34 |
| 0 Washes | 3.19 | 1.36 |
| 5 Washes | 3.69 | 0.66 |
| 20 Washes | 4.66 | 0.73 |
| Maximum Value | 4.66 | 0.73 |

TABLE 3B
Staphylococcus aureus

| Sample Description | Average Log Kill Rate | Std. Deviation |
|---|---|---|
| Viability | 1.04E+06 | 4.82E+05 |
| Internal Control | −0.12 | 0.15 |
| Sample Control | −0.12 | 0.17 |
| 0 Washes | 1.50 | 0.00 |
| 5 Washes | 2.04 | 0.65 |
| 20 Washes | 2.00 | 0.00 |
| Maximum Value | 4.40 | 0.35 |

Vertical Wicking Test

A one-inch by six-inch piece of fabric was suspended above a dish of deionized water that was placed on a digital scale. The fabric was submerged into the water and the timer begun. Scale readings were monitored at predetermined time intervals to determine the fabric's ability to wick moisture. The test was run on the fabric of Example 1 and a similar piece of microdenier nonwoven fabric that was not treated with ALPHASAN®. The results of TABLE 4 indicate a slight improvement in the fabric's ability to wick moisture when the fabric is treated with a silver-ion containing antimicrobial agent. The % improvement, as shown below, is calculated by subtracting the grams of deionized water wicked by the untreated fabric from the grams of deionized water wicked by the treated fabric divided by the grams of deionized water wicked by the untreated fabric and multiplied by 100%.

$$\frac{Grams wicked treated fabric - Grams wicked untreated fabric}{Grams wicked untreated fabric} \times 100 \% = \% Improvement$$

TABLE 4
Amount of Moisture Wicked by Treated and
Untreated Fabric Samples

| | Grams of Deionized Water | | |
|---|---|---|---|
| | Wicked by | Wicked by Treated | % |
| Time (minutes) | Untreated Fabric | Fabric (Example 1) | Improvement |
| 0 | 0 | 0 | — |
| 0.5 | 314.6 | 344.5 | 9.5% |
| 1 | 360.8 | 387.9 | 7.5% |
| 5 | 551.1 | 588.9 | 6.9% |
| 10 | 704.9 | 743.9 | 5.5% |
| 20 | 936.3 | 980.7 | 4.7% |
| 30 | 1122.5 | 1170.6 | 4.3% |

We claim:

1. A microdenier nonwoven fabric having a surface, at least a portion of which is coated with a non-electrically conductive finish,
wherein said finish comprises at least one silver-ion containing compound selected from the group consisting of silver zirconium phosphate, silver zeolite, silver glass, and any mixtures thereof, and at least one binder material; and
wherein said coated nonwoven fabric exhibits a silver-ion release retention level of at least 4.5%, with an initial amount of available silver ion of at least 1700 ppb, as measured by an artificial sweat test, wherein said silver-ion release retention level is measured after at least 10 washes, said washes being performed with bleach in accordance with the Industrial Wash Procedure described herein.

2. The coated nonwoven fabric of claim 1, wherein said silver-ion release retention level is at least 8%.

3. The coated nonwoven fabric of claim 1, wherein said silver-ion containing compound is silver zirconium phosphate.

4. The coated nonwoven fabric of claim 1, wherein said at least one binder material is a polyurethane binder.

5. The coated nonwoven fabric of claim 1, wherein said at least one binder material is an acrylic binder.

6. The coated nonwoven fabric of claim 1, wherein said nonwoven fabric is comprised of continuous composite filaments, each of said composite filaments comprising at least a first filament material and a second filament material that are at least partially longitudinally separated into elementary filaments of said first filament material and said second filament material.

7. The coated nonwoven fabric of claim 6, wherein said nonwoven fabric is a hydroentangled web.

8. The coated nonwoven fabric of claim 6, wherein said nonwoven fabric is a hydroentangled web that has been thermally bonded.

9. The coated nonwoven fabric of claim 6, wherein said first filament material is a polyester material selected from the group consisting of polyethylene terephthalate (PET), polybutylene terephthalate (PBT), polytrimethylene terephthalate (PTT), and polylactic acid (PLA).

10. The coated nonwoven fabric of claim 9, wherein said first filament material is PET.

11. The coated nonwoven fabric of claim 6, wherein said second filament material is a polyamide selected from the group consisting of nylon 6, nylon 66, nylon 11, and nylon 610.

12. The coated nonwoven fabric of claim 11, wherein said second filament material is nylon 6.

13. The coated nonwoven fabric of claim 6, wherein said first filament material is PET and said second filament material is nylon 6.

14. The coated nonwoven fabric of claim 13, wherein said coated nonwoven fabric absorbs at least 4.3% more deionized water than said nonwoven fabric having no coating.

15. The coated nonwoven fabric of claim 14, wherein said coated nonwoven fabric absorbs at least 5.5% more deionized water than said nonwoven fabric having no coating.

16. The coated nonwoven fabric of claim 15, wherein said coated nonwoven fabric absorbs at least 7.5% more deionized water than said nonwoven fabric having no coating.

17. A microdenier nonwoven fabric having a surface, at least a portion of which is coated with a non-electrically conductive finish,
wherein said finish comprises at least one silver-ion containing compound selected from the group consisting of silver zirconium phosphate, silver zeolite, silver glass, and any mixtures thereof, and at least one binder material; and
wherein said coated nonwoven fabric exhibits a log kill rate for Klebsiella pneumoniae after a 22-hour exposure in accordance with AATCC Test Method 100-1993 of at least 3.69, wherein said log kill rate is measured after at least five washes, said washes being with bleach in accordance with the Industrial Wash Procedure described herein.

18. The coated nonwoven fabric of claim 17, wherein said silver-ion containing compound is silver zirconium phosphate.

19. The coated nonwoven fabric of claim 17, wherein said at least one binder material is a polyurethane binder.

20. The coated nonwoven fabric of claim 17, wherein said at least one binder material is an acrylic binder.

21. The coated nonwoven fabric of claim 17, wherein said nonwoven fabric is comprised of continuous composite filaments, each of said composite filaments comprising at least a first filament material and a second filament material that are at least partially longitudinally separated into elementary filaments of said first filament material and said second filament material.

22. The coated nonwoven fabric of claim 21, wherein said nonwoven fabric is a hydroentangled web.

23. The coated nonwoven fabric of claim 21, wherein said nonwoven fabric is a hydroentangled web that has been thermally bonded.

24. The coated nonwoven fabric of claim 21, wherein said first filament material is a polyester material selected from the group consisting of polyethylene terephthalate (PET), polybutylene terephthalate (PBT), polytrimethylene terephthalate (PTT), and polylactic acid (PLA).

25. The coated nonwoven fabric of claim 24, wherein said first filament material is PET.

26. The coated nonwoven fabric of claim 21, wherein said second filament material is a polyamide selected from the group consisting of nylon 6, nylon 66, nylon 11, and nylon 610.

27. The coated nonwoven fabric of claim 26, wherein said second filament material is nylon 6.

28. The coated nonwoven fabric of claim 21, wherein said first filament material is PET and said second filament material is nylon 6.

29. A microdenier nonwoven fabric having a surface, at least a portion of which is coated with a non-electrically conductive finish,
wherein said finish comprises at least one silver-ion containing compound selected from the group consisting of silver zirconium phosphate, silver zeolite, silver glass, and any mixtures thereof, and at least one binder material; and
wherein said coated nonwoven fabric exhibits a log kill rate for Staphylococcus aureus after a 22-hour exposure in accordance with AATCC Test Method 100-1993 of at least 2.00, wherein said log kill rate is measured after at least twenty washes, said washes being with bleach in accordance with the Industrial Wash Procedure described herein.

30. The coated nonwoven fabric of claim 29, wherein said silver-ion containing compound is silver zirconium phosphate.

31. The coated nonwoven fabric of claim 29, wherein said at least one binder material is a polyurethane binder.

32. The coated nonwoven fabric of claim 29, wherein said at least one binder material is an acrylic binder.

33. The coated nonwoven fabric of claim 29, wherein said nonwoven fabric is comprised of continuous composite filaments, each of said composite filaments comprising at least a first filament material and a second filament material that are at least partially longitudinally separated into elementary filaments of said first filament material and said second filament material.

34. The coated nonwoven fabric of claim 33, wherein said nonwoven fabric is a hydroentangled web.

35. The coated nonwoven fabric of claim 33, wherein said nonwoven fabric is a hydroentangled web that has been thermally bonded.

36. The coated nonwoven fabric of claim 33, wherein said first filament material is a polyester material selected from the group consisting of polyethylene terephthalate (PET), polybutylene terephthalate (PBT), polytrimethylene terephthalate (PTT), and polylactic acid (PLA).

37. The coated nonwoven fabric of claim 36, wherein said first filament material is PET.

38. The coated nonwoven fabric of claim 33, wherein said second filament material is a polyamide selected from the group consisting of nylon 6, nylon 66, nylon 11, and nylon 610.

39. The coated nonwoven fabric of claim 38, wherein said second filament material is nylon 6.

40. The coated nonwoven fabric of claim 33, wherein said first filament material is PET and said second filament material is nylon 6.
